(19) United States
(12) Patent Application Publication
(10) Pub. No.: US 2010/0237844 A1
(43) Pub. Date: Sep. 23, 2010

(54) REFERENCE VOLTAGE PROVIDING CIRCUIT AND RELATED METHOD

(76) Inventor: Hung-Teng Yeh, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/725,468

(22) Filed: Mar. 17, 2010

(30) Foreign Application Priority Data
Mar. 18, 2009 (TW) 098108824

(51) Int. Cl. G05F 1/10

(52) U.S. Cl. 323/284

(57) ABSTRACT

A reference voltage providing circuit, for providing a reference voltage to an error amplifier comparing the reference voltage and a feedback voltage. The reference voltage providing circuit comprises: a voltage detection module, for detecting the feedback voltage to generate a control signal; and a controllable voltage providing module, for providing the reference voltage according to the control signal.

### BACKGROUND OF THE INVENTION

1. Field of the Invention

The present invention relates to a voltage providing circuit, to a voltage regulating circuit utilizing the voltage providing circuit, and to a related method thereof, and particularly relates to a voltage providing circuit that may ease the problems of voltage overshooting and voltage undershooting during loading transforming, to a voltage regulating circuit utilizing the voltage providing circuit, and to a related method thereof.

2. Description of the Prior Art

In electric power systems or electronic systems, a voltage regulating circuit is used to regulate an output voltage, providing a stable voltage to the load in the following stage. FIG. 1 is a schematic diagram illustrating a voltage regulating circuit 100 of prior art. Voltage regulating circuit 100 includes a voltage regulating module 101, an error amplifier 103, an inductor 105, resistors 107, 109, and a capacitor 111. Inductor 105, resistors 107, 109 and capacitor 111 are coupled to loading 125. Voltage regulating module 101 including a comparator 113, a SR flip flop 115, a clock signal source 117, a control circuit 119, a PMOS 121, and a NMOS 123 is utilized to output an output voltage Vₒᵤₜ, which in turn renders a feedback signal FB at the connection point between resistors 107 and 109. Error amplifiers 103 outputs a difference signal DIS according to comparing the voltage value of feedback signal FB and a reference voltage V_{ref}. Voltage regulating module 101 increases or decreases the output power drained from voltage source Vᵢₙ according to the difference signal DIS so as to substantially fix Vₒᵤₜ at a targeted value.

However, such structure may induce the problems of voltage overshooting and undershooting. During the transient when loading 125 suddenly changes from light load to heavy load, the current from inductor 105 is not enough to support necessary current of the loading 125 so the output voltage Vₒᵤₜ at terminal 127 will suddenly drop accordingly, resulting in the voltage undershooting problem. Oppositely, During the transient when loading 125 suddenly changes from heavy load to light load, the current from inductor 105 is suddenly higher than required so the output voltage Vₒᵤₜ at terminal 127 will suddenly rise up, resulting in the voltage overshooting problem. Moreover, the amount of voltage undershooting or overshooting varies with the value of the capacitor 111, which will worsen the stability of the circuit.

Accordingly, a novel circuit structure is needed to solve above-mentioned problems.

### SUMMARY OF THE INVENTION

One object of the present invention is to provide a voltage providing circuit, which correspondingly changes the provided voltage according if a voltage rising or a voltage drop occurs.

One embodiment of the present invention provides a reference voltage providing circuit, for providing a reference voltage to an error amplifier comparing the reference voltage and a feedback voltage. The reference voltage providing circuit comprises: a voltage detection module, for detecting the feedback voltage to generate a control signal; and a controllable voltage providing module, for providing the reference voltage according to the control signal.

Another embodiment of the present invention discloses a voltage regulating circuit comprising: a voltage providing module, for generating an adjusting voltage according to a comparison result; an error amplifier, for comparing a feedback voltage corresponding to the adjusting voltage and a reference voltage to generate the comparison result; and a reference voltage providing circuit, for detecting the feedback voltage to provide the reference voltage, wherein the reference voltage providing circuit approximately provides a predetermined value as the reference voltage when a difference value between the feedback voltage and the predetermined value is in a predetermined range, and the reference voltage providing circuit temporarily controls the reference voltage to be different from the predetermined value when the difference value between the feedback voltage and the predetermined value is not in the predetermined range whereby accelerating the feedback voltage back to the predetermined value. The reference voltage providing circuit comprises: a voltage detection module, for detecting the feedback voltage to generate a control signal; and a controllable voltage providing module, for providing the reference voltage according to the control signal.

Another embodiment of the present invention discloses a method for providing a reference voltage to an error amplifier, wherein the error amplifier compares the reference voltage and a feedback voltage, where the method comprises: detecting the feedback voltage; controlling the reference voltage to be approximately the same as the predetermined value when a difference value between the feedback voltage and the predetermined value is in a predetermined range; and controlling the reference voltage to be temporarily different from the predetermined value when the difference value between the feedback voltage and the predetermined value is not in the predetermined range whereby accelerating the feedback voltage back to the predetermined value.

Via above mentioned embodiment, the voltage providing circuit can change provided voltage according if voltage overshooting or voltage undershooting happens. Accordingly, the voltage providing circuit according to the present invention can compensate voltage overshooting or voltage undershooting to provide a stable output voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram illustrating a prior art voltage regulating circuit.

FIG. 2 illustrates a voltage regulating circuit according to an embodiment of the present invention.

FIG. 3 illustrates an embodiment of the detail structures for the reference voltage providing circuit shown in FIG. 2.

FIG. 4 illustrates an embodiment of the detail structures for the voltage undershooting detection module shown in FIG. 3.

FIG. 5 illustrates an embodiment of the detail structures for the voltage overshooting detection module shown in FIG. 3.

FIG. 6 illustrates an embodiment of the controllable voltage providing module shown in FIG. 2.

FIG. 7 illustrates a more detail embodiment of a circuit diagram shown in FIG. 4.

FIG. 8 illustrates a more detail embodiment of a circuit diagram shown in FIG. 5.

FIG. 9 is a schematic illustrating the voltage generated from the voltage regulation circuit according to the present invention.

FIG. 10 is a schematic diagram illustrating the voltage generated by the voltage regulating circuit according to the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function.

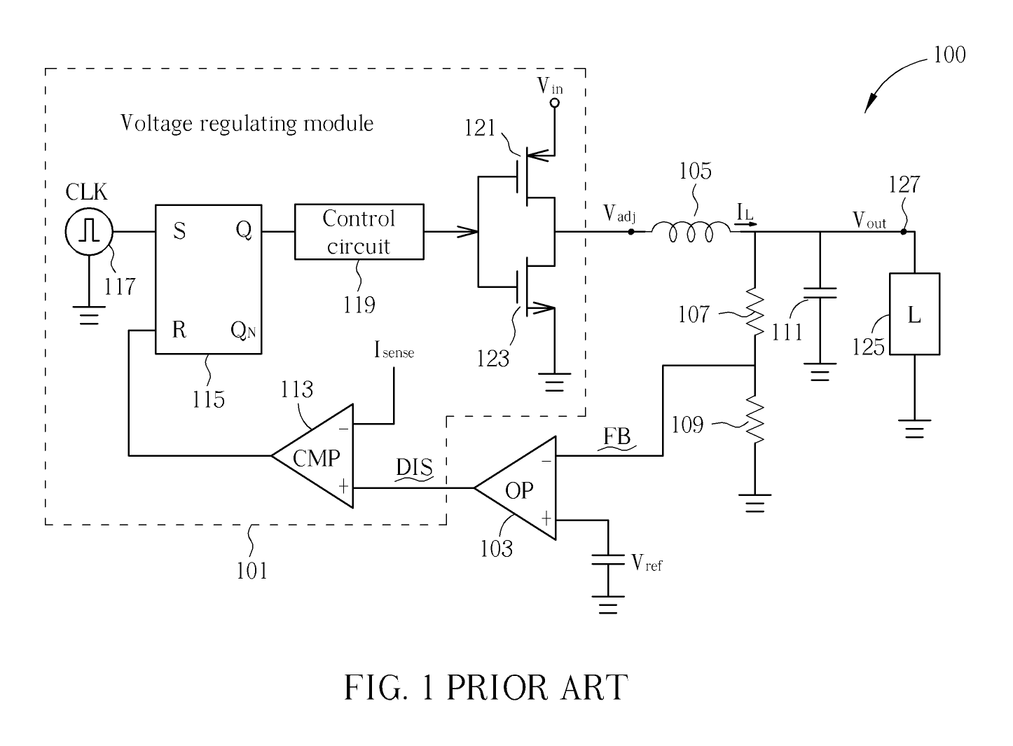

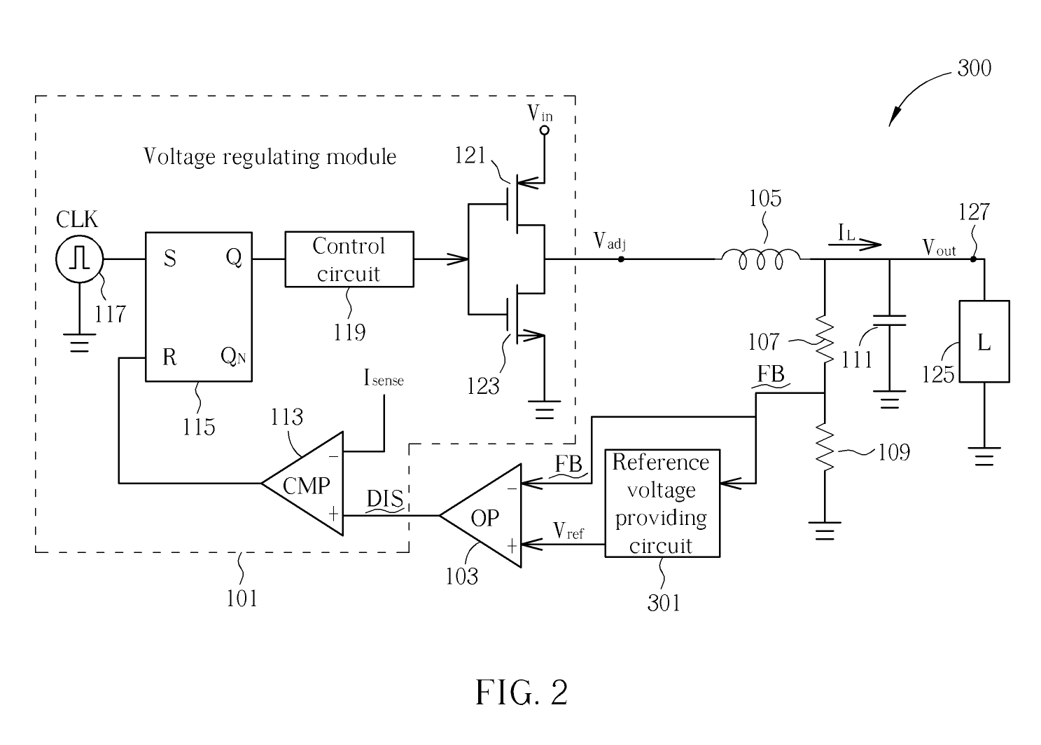

FIG. 2 illustrates a voltage regulating circuit 300 according to an embodiment of the present invention. Comparing with the voltage regulating circuit 100 shown in FIG. 1, voltage regulating circuit 300 further includes a reference voltage providing circuit 301 for changing reference voltage V_{ref} input to error amplifier 103. Specifically, reference voltage providing circuit 301 detects feedback signal FB and changes reference voltage V_{ref} when voltage undershooting or overshooting occurs. By this way, voltage regulating module 101 can rapidly response to ease the phenomenon of voltage overshooting or undershooting.

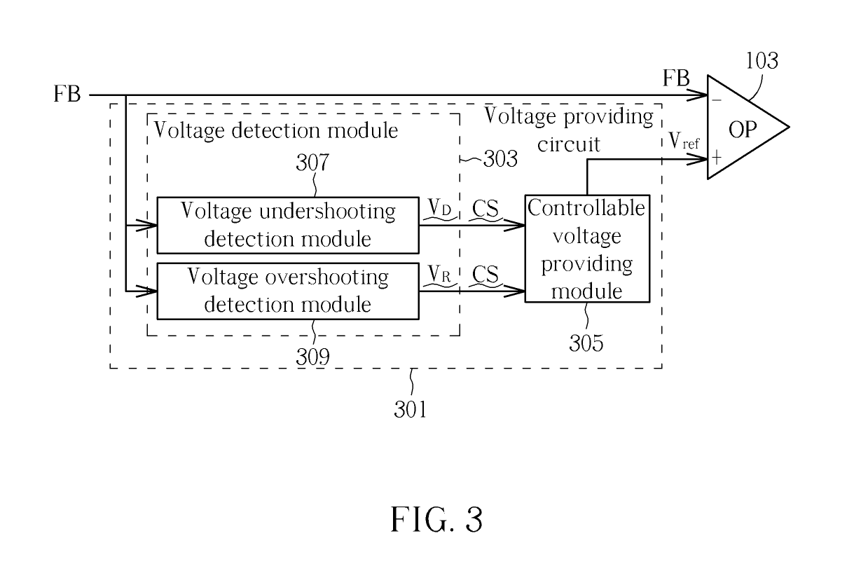

FIG. 3 illustrates an embodiment of the detail structure of reference voltage providing circuit 301 shown in FIG. 2. Reference voltage providing circuit 301 includes a voltage detection module 303 and a controllable voltage providing module 305. Voltage detection module 303 is utilized for detecting a voltage value V_{FB} of feedback signal FB to generate a control signal CS. Controllable voltage providing module 305 receives control signal CS and accordingly provides reference voltage V_{ref}. Generally, voltage regulating 300 of FIG. 2 controls voltage value V_{FB} of feedback signal FB to approach reference voltage V_{ref}. In other words, when in a stable state, voltage value V_{FB} will be substantially equal to a predetermined value of reference voltage V_{ref}.

Voltage undershooting detection module 307 of voltage detection module 303 is utilized to detect if a voltage value of the feedback signal FB is far below the predetermined value or lower than a first predetermined voltage and thus generates an undershooting voltage indication signal V_{D} as control signal CS. Similarly, voltage overshooting detection module 309 is utilized to detect if a voltage value of the feedback signal FB is far above the predetermined value or higher than a second predetermined voltage, generating an overshooting voltage indication signal V_{R} as control signal CS.

In one embodiment, control signal CS is a pulse signal. And controllable voltage providing module 305 can change the reference voltage V_{ref} according to the pulse width of the pulse signal so as to make the pulse signal temporarily different from the predetermined value. Accordingly, the operation of reference voltage providing circuit 301 shown in FIG. 3 can be summarized as follows: voltage detection module 303 sends a corresponding pulse signal as control signal CS when a voltage overshooting or undershooting event occurs, and then controllable voltage providing module 305 temporarily changes reference voltage V_{ref} accordingly. It should be noted that the circuit shown in FIG. 3 is not limited to the circuit structure shown in FIG. 2. For example, the voltage output from reference voltage providing circuit 301 is not limited to be input to a comparator as the reference voltage. Such variation should also be included in the scope of the present invention.

Voltage detection module 303 detects the feedback voltage. Controllable voltage providing module 305 controls the reference voltage to be approximately the same as the predetermined value when the difference between the feedback voltage and the predetermined value is within a predetermined range. If the difference is outside the predetermined range, the reference voltage is controlled to be temporarily different from the predetermined value.

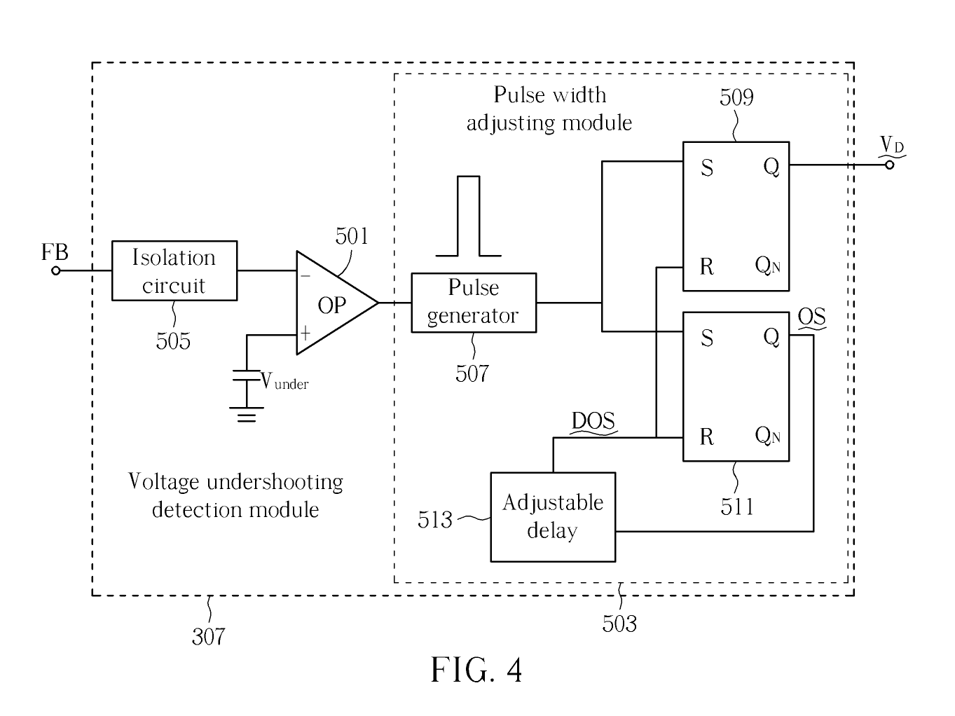

FIG. 4 illustrates an embodiment of the detail structures of voltage undershooting detection module shown in FIG. 3. Voltage undershooting detection module 307 includes a comparator 501 and a pulse width adjusting module 503. Comparator 501 is utilized to compare voltage value V_{FB} of feedback signal FB with predetermined voltage V_{under}. If feedback signal FB is smaller than predetermined voltage V_{under}, implying voltage undershooting occurs, pulse width adjusting module 503 generates a pulse signal as voltage undershooting signal V_{D}. Undershooting detection module 307 could further include an isolation circuit 505 for isolating the noise part of the feedback signal FB from reaching or misleading comparator 501.

In this embodiment, pulse width adjusting module 503 comprises: pulse generator 507, SR flip flops 509, 511 and adjustable delay 513. Pulse generator 507 generates a pulse when the voltage value of feedback signal FB is smaller than predetermined voltage V_{under}. Of SR flip flops 511, set terminal receives the pulse, reset terminal receives a delayed output signal DOS, and output terminal outputs an output signal OS. Adjustable delay 513 delays the output signal OS to generate delayed output signal DOS. Via the cooperation of pulse generator 507, SR flip flop 509, 511 and adjustable delay 513, a pulse signal can be generated as voltage undershooting indication signal V_{D}, of which the pulse width can be controlled by adjustable delay 513. Persons skilled in the art can easily understand how a desired pulse signal can be generated via pulse generator 507, SR flip flops 509, 511, and adjustable delay 513 to generate desired pulse signal, and thus it is omitted for brevity here.

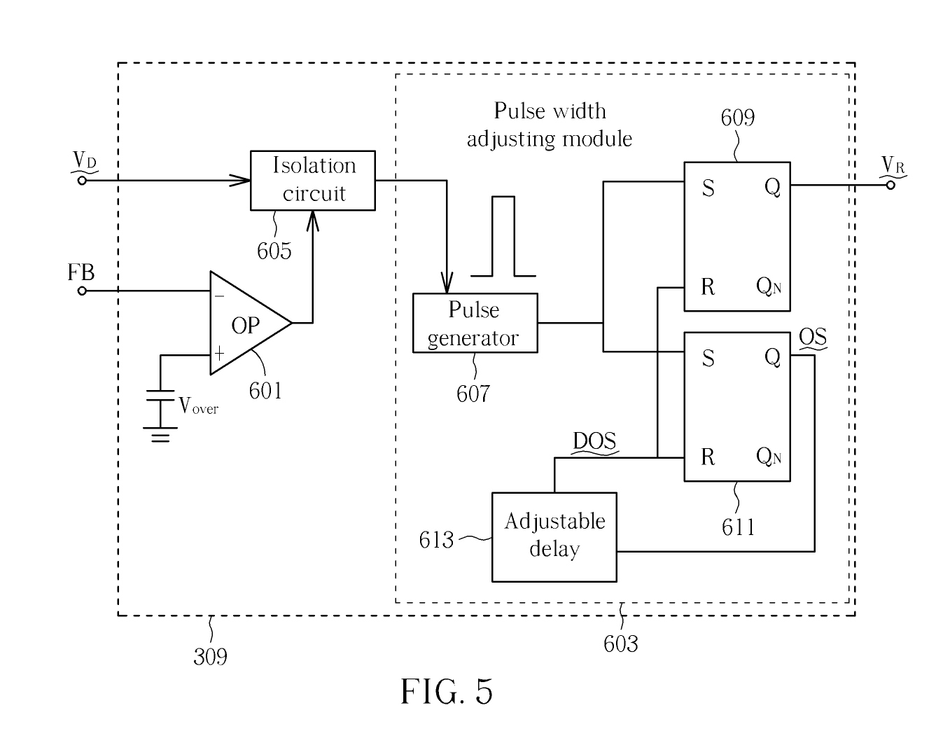

FIG. 5 illustrates an embodiment of the detail structures of voltage overshooting detection module 309 shown in FIG. 3. Voltage overshooting detection module 309 includes comparator 601, pulse width adjusting module 603, and isolation circuit 605. Comparator 601 is utilized to compare feedback signal FB with predetermined voltage Vₒᵥₑᵣ, and it is determined that the voltage overshooting occurs when voltage value V_{FB} of feedback signal FB is larger than predetermined voltage Vₒᵥₑᵣ. pulse width adjusting module 603 is utilized to generate a pulse signal PWN when a voltage level of feedback signal FB is larger than predetermined voltage Vₒᵥₑᵣ. Isolation circuit 605 isolates the noise of voltage undershooting indication signal V_{D} and triggers pulse width adjusting module 603 to generate voltage overshooting indication signal V_{R} according to voltage undershooting indication signal V_{D} and the comparing result from comparator 601. In this embodiment, pulse width adjusting module 603 includes the same devices in pulse width adjusting module 503, such as pulse generator 607, SR flip flops 609,611 and adjustable delay 613.

The difference between pulse width adjusting module 603 and pulse width adjusting module 503 is the source of input. Pulse generator 507 of pulse width adjusting module 503 receives a comparing result signal from the comparator, but pulse generator 607 of pulse width adjusting module 603 receives an output signal from isolation circuit 605. Other structures and operations of pulse width adjusting modules 503 and 603 are the same, then the related description omitted herein.

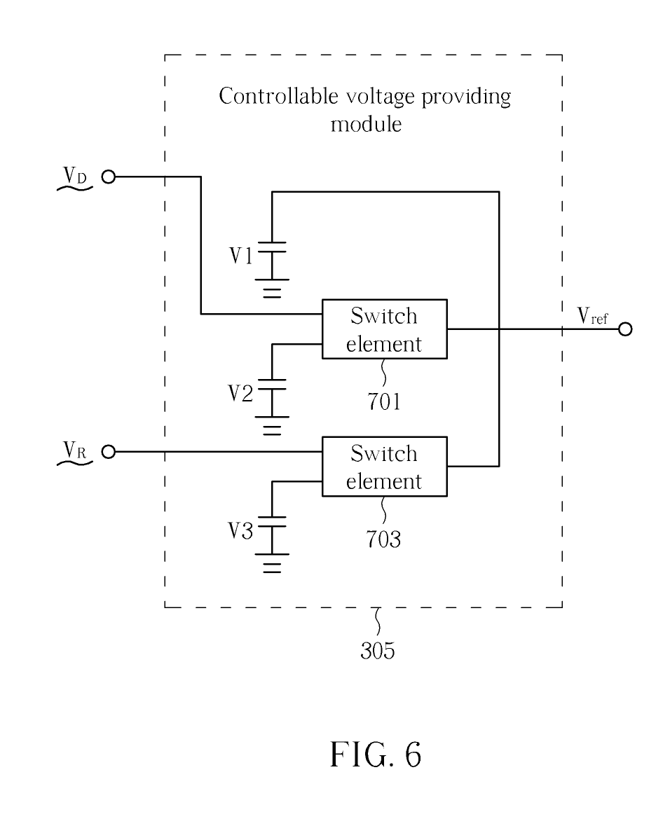

FIG. 6 illustrates an embodiment of controllable voltage providing module 305 shown in FIG. 2. Controllable voltage providing module 305 includes a switch element 701 and a switch element 703 coupled to a second voltage V₂ and a third voltage V₃ respectively. In this case, voltage undershooting indication signal V_{D} controls switch element 701 and voltage overshooting indication signal V_{R} controls switch element 703. Besides, a first voltage V₁ is output as the output voltage when no voltage undershooting indication signal V_{D} or voltage overshooting indication signal V_{R} exists. Reference voltage V_{ref} can be changed according to switch elements 701 and 703. For example, when voltage undershooting indication signal V_{D} occurs, the switch element 701 conducts so that the voltage value of reference voltage V_{ref} is determined by both first voltage V₁ and second voltage V₂. Additionally, another embodiment of the present application can further include another switch element (not shown) coupled to first voltage V₁, and such switch element can be jointly controlled by voltage undershooting indication signal V_{D} and voltage overshooting indication signal V_{R}. For example, if either voltage undershooting or voltage overshooting occurs, either second voltage V₂ or third voltage V₃ decides reference voltage V_{ref} and first voltage V₁ is blocked from influencing reference voltage V_{ref}. Such structure can also reach similar function. Persons skilled in the art can easily understand the detail implement of this structure, and thus the drawing and description are omitted for brevity here.

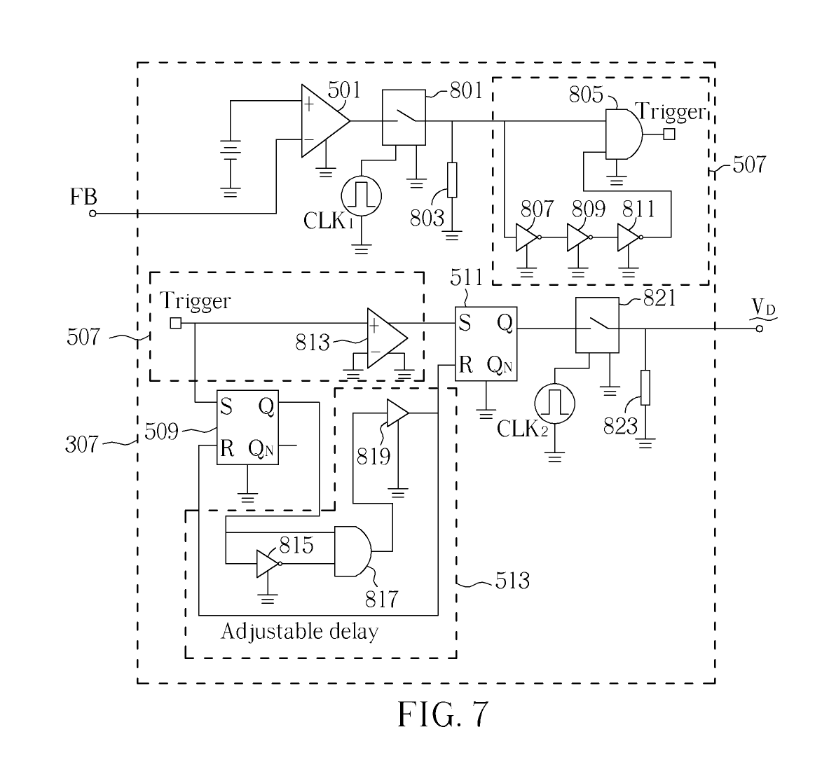

FIG. 7 illustrates a more detail embodiment of a circuit diagram shown in FIG. 4. Please jointly refer to FIGS. 4 and 7 to understand the circuit structure shown in FIG. 4. It should be noted that the circuit structures shown in FIG. 7 is only for example and does not mean to limit the present invention. As shown in FIG. 7, isolation circuit 505, not shown, may be integrated in comparator 501. Switch 801, resistor 803, and clock source CLK1 can be regarded as a switch module to determine if the signal can pass. Pulse generator 507 comprises an AND gate 805, inverters 807, 809, 811, and a differential amplifier 813. Adjustable delay 513 includes an inverter 815, an AND gate 817, and a buffer 819. Switch 821, resistor 823, and clock source CLK2 can be regarded as another switch module. Persons skilled in the art can easily understand the operation of the circuit structure shown in FIG. 7 according to the circuit structure and above mentioned description, then the operation of the circuit omitted for brevity here.

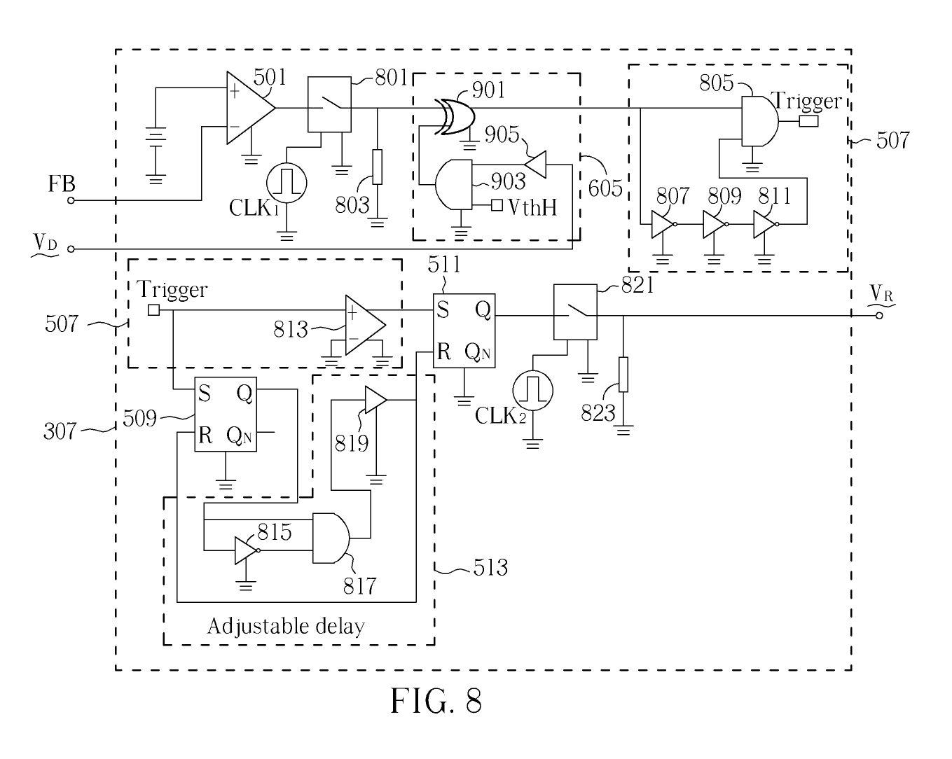

FIG. 8 illustrates a more detail embodiment of a circuit diagram shown in FIG. 5. The circuit structure in FIG. 8 is similar to that in FIG. 7. The only differences is that the circuit structure of FIG. 7 further includes an isolation circuit 605. In this embodiment, isolation circuit 605 includes a XOR gate 901, an AND gate 903, and a buffer 905. Persons skilled in the art can easily understand the operation of the circuit structure shown in FIG. 8 according to the drawing and the above mentioned description, then the further description omitted for brevity here.

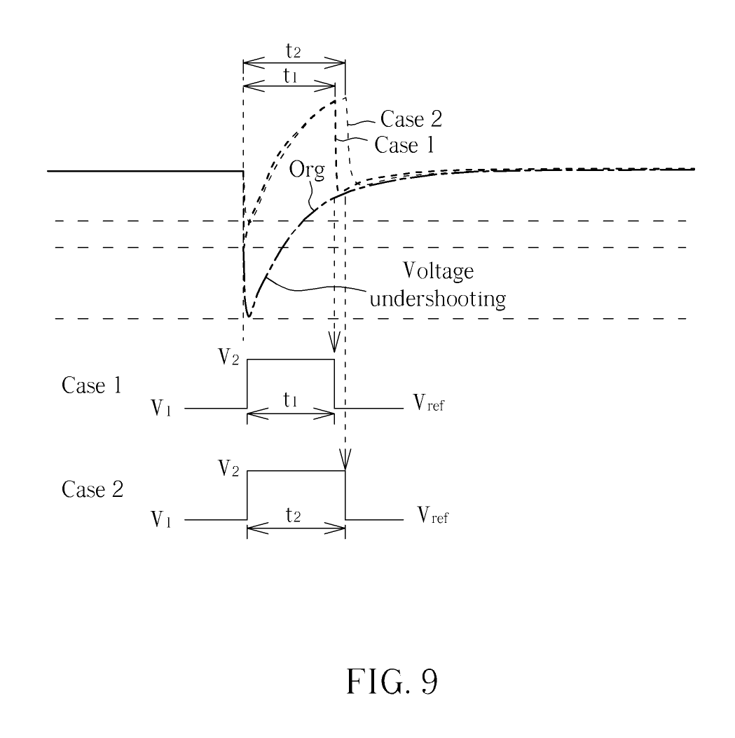

FIG. 9 is a schematic illustrating the voltage generated from the voltage regulation circuit according to the present invention. Specifically, FIG. 9 illustrates how to utilize the voltage regulating circuit of the present invention to compensate when the voltage undershooting occurs. The voltage curve Org indicates a prior art voltage curve having voltage undershoot without any compensation mechanism. The voltage curves of Case 1 and Case 2 indicate the wave form of reference voltage V_{ref} generated by utilizing the voltage regulating circuit according to the present invention to compensate the voltage. As shown by voltage curve Org, a large voltage drop occurs when the voltage undershooting occurs. But in Case 1 and Case 2, after the voltage undershoots, reference voltage V_{ref} varies from V₁ shown in FIG. 9 to V₂, quick resulting in voltage rising. The rising time is proportion to the time period when the voltage undershooting indication signal V_{D} stays at high level (i.e. the reference voltage is V₂).

In the example shown in FIG. 9, the voltage undershooting indication signals V_{D} of Case 1 and Case 2 are different in the pulse width, such that the voltage rising times of both cases are also different. Specifically, when the voltage undershooting occurs in Case 1, reference voltage V_{ref} changes from V₁ to V₂ and the voltage correspondingly rises up in the time period t₁. Similarly, in Case 2, the voltage correspondingly rises up in the time period t2. That is, the present invention can optimize the time period when reference voltage V_{ref} changes after the occurrence of the voltage undershooting or undershooting. As can be concluded from FIG. 9, comparing to voltage curves Org having no compensation mechanism, the voltage curves of Cases 1 and 2 having compensating mechanism are more stable.

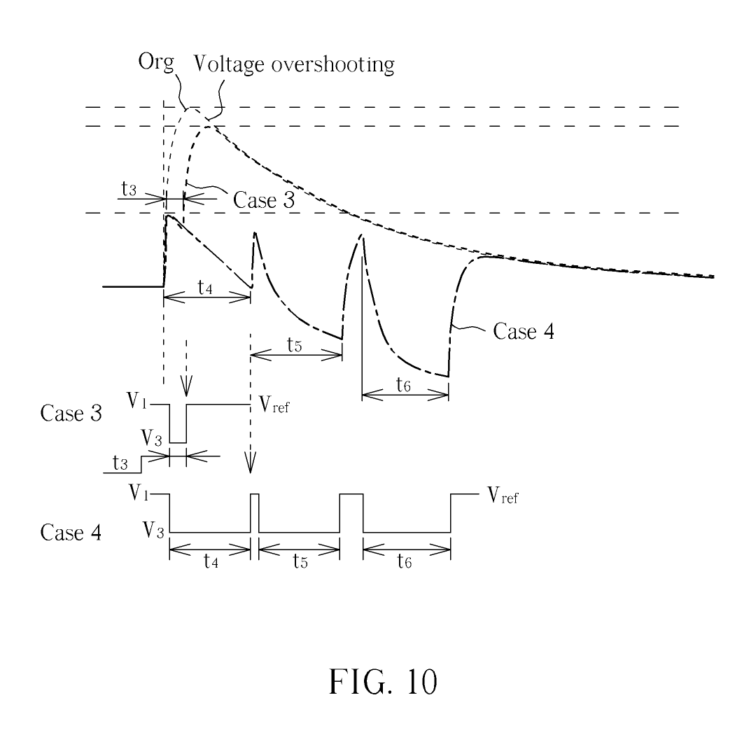

FIG. 10 is a schematic diagram illustrating the voltage generated by the voltage regulating circuit according to the present invention. Specifically, FIG. 10 illustrates how to utilize the voltage regulating circuit of the present invention to compensate when a voltage overshooting occurs. Similar to FIG. 9, the voltage curve Org indicates a prior art voltage curve having voltage overshooting without any compensation mechanism. The voltage curves of Cases 3 and 4 indicate the voltage curves according to the present invention having compensation to the voltage. According to the voltage curve Org, a large voltage rising occurs when a voltage overshooting occurs. But in Cases 3 and 4, after the detection of the voltage overshoot, reference voltage V_{ref} changes from V₁ to V₃, causing output voltage dropping. In Case 3, the detection of the voltage overshoot causes reference voltage V_{ref} changes once for a time period of t₃. In Case 4, the same detection causes reference voltage V_{ref} changes three times for three time periods (including t₄, t₅ and t₆), each being longer than t₃. Comparing to voltage curves Org, the voltage curves of Cases 3 and 4 having compensating mechanism are more stable so as to reduce the probability that the voltage regulating circuit makes wrong determination.

Via above mentioned embodiment, the voltage providing circuit can change provided voltage according to whether voltage overshooting or voltage undershooting happens. So the voltage providing circuit according to the present invention can compensate voltage overshooting or voltage undershooting to provide a stable output voltage.

Those skilled in the art will readily observe that numerous modifications and alterations of the device and method may be made while retaining the teachings of the invention.

What is claimed is:

1. A reference voltage providing circuit, for providing a reference voltage to an error amplifier comparing the reference voltage and a feedback voltage, the reference voltage providing circuit comprising:
a voltage detection module, for detecting the feedback voltage to generate a control signal; and
a controllable voltage providing module, for providing the reference voltage according to the control signal.

2. The reference voltage providing circuit of claim 1, wherein the controllable voltage providing module approximately provides a predetermined value as the reference voltage when a difference value between the feedback voltage and the predetermined value is within a predetermined range, and the controllable voltage providing module temporarily controls the reference voltage to be different from the predetermined value when the difference value between the feedback voltage and the predetermined value is not in the predetermined range whereby accelerating the feedback voltage back to the predetermined value.

3. The reference voltage providing circuit of claim 1, wherein the voltage detection module generates a pulse signal as the control signal.

4. The reference voltage providing circuit of claim 1, wherein the voltage detection module comprises:
a voltage undershooting detection module, for detecting if the feedback voltage is lower than a first predetermined voltage to generate a voltage undershooting indication signal as the control signal; and
a voltage overshooting detection module, for detecting if the feedback voltage is higher than a second predetermined voltage to generate a voltage overshooting indication signal as the control signal.

5. The reference voltage providing circuit of claim 4, wherein the voltage detection module comprises:
a comparator, for comparing the feedback voltage and the first predetermined voltage; and
a pulse width adjusting module, for generating a pulse signal as the voltage undershooting indicating signal when the feedback voltage is smaller than the first predetermined voltage.

6. The reference voltage providing circuit of claim 4, wherein the controllable voltage supplying module comprises:
a predetermined voltage source, for providing a predetermined voltage;
a first switch coupled to a first voltage and controlled by the voltage undershooting indication signal; and
a second switch, coupled to a second voltage and controlled by the voltage overshooting indication signal.

7. A voltage regulating circuit, comprising:
a voltage providing module, for generating an adjusting voltage according to a comparison result;
an error amplifier, for comparing a feedback voltage corresponding to the adjusting voltage and a reference voltage to generate the comparison result; and
a reference voltage providing circuit, for detecting the feedback voltage to provide the reference voltage, wherein the reference voltage providing circuit approximately provides a predetermined value as the reference voltage when a difference value between the feedback voltage and the predetermined value is in a predetermined range, and the reference voltage providing circuit temporarily controls the reference voltage to be different from the predetermined value when the difference value between the feedback voltage and the predetermined value is not in the predetermined range whereby accelerating the feedback voltage back to the predetermined value, wherein the reference voltage providing circuit comprises:
a voltage detection module, for detecting the feedback voltage to generate a control signal; and
a controllable voltage providing module, for providing the reference voltage according to the control signal.

8. The voltage regulating circuit of claim 7, wherein the voltage detection module generates a pulse signal as the control signal.

9. The voltage regulating circuit of claim 7, wherein the voltage detection module comprises:
a voltage undershooting detecting voltage, for detecting the feedback voltage and for generating a voltage undershooting indication signal as the control signal when the feedback voltage is lower than a first predetermined voltage; and
a voltage overshooting detection module, for detecting the feedback voltage and for generating a voltage overshooting indication signal as the control signal when the feedback voltage is higher than a second predetermined voltage.

10. The voltage regulating circuit of claim 9, wherein the voltage undershooting detection module comprises:
a comparator, for comparing the feedback voltage and the first predetermined voltage; and
a pulse width adjusting module, for generating a pulse signal as the voltage undershooting indicating signal when the feedback voltage having a voltage value smaller than the first predetermined voltage.

11. The voltage regulating circuit of claim 10, further comprising an isolation circuit, for isolating noise of the feedback signal before the feedback signal enters the comparator.

12. The voltage regulating circuit of claim 9, wherein the controllable voltage supplying module comprises:
a predetermined voltage source, for providing a predetermined voltage;
a first switch, coupled to a first voltage and controlled by the voltage undershooting indication signal; and
a second switch, coupled to a second voltage and controlled by the voltage overshooting indication signal.

13. A method for providing a reference voltage to an error amplifier, wherein the error amplifier compares the reference voltage and a feedback voltage, where the method comprises:
detecting the feedback voltage;
controlling the reference voltage to be approximately the same as a predetermined value when a difference value between the feedback voltage and the predetermined value is in a predetermined range; and
controlling the reference voltage to be temporarily different from the predetermined value when the difference value between the feedback voltage and the predetermined value is not in the predetermined range whereby accelerating the feedback voltage back to the predetermined value.

14. The method of claim 13, comprising:
setting the reference voltage to be a first voltage lower than the predetermined value in a predetermined time period, when the feedback voltage is lower than a first predetermined voltage; and
setting the reference voltage to be a second voltage higher than the predetermined value in a predetermined time period, when the feedback voltage is higher than a second predetermined voltage.

15. The method of claim 13, comprising:
controlling a voltage regulating module according to the error amplifier to generate an adjusting voltage, wherein the feedback voltage corresponds to the adjusting voltage.
